(19) United States
(12) Patent Application Publication
(10) Pub. No.: US 2009/0002252 A1
(43) Pub. Date: Jan. 1, 2009

(54) TURNSTYLE ANTENNA ELEMENT

(75) Inventor: Myron D. Fanton, Evansville, IN (US)

Correspondence Address: C RICHARD MARTIN;MARTIN & MARTIN, ATTORNEYS AT LAW, PC, PO BOX 29, BOONVILLE, IN, 47601, US

(73) Assignee: ELECTRONICS RESEARCH, INC., Chandler, IN (US)

(21) Appl. No.: 12/104,414

(22) Filed: Apr. 16, 2008

Related U.S. Application Data
(60) Provisional application No. 60/911,929, filed on Apr. 16, 2007.

(51) Int. Cl. H01Q 21/26

(52) U.S. Cl. 343/797

(57) ABSTRACT

An improved antenna radiating element for a Super-turnstile antenna is provided. The radiating element includes an intermediate conductive rod having an upper terminating rod connected thereto proximal to an upper end thereof and a lower terminating rod connected thereto proximal to a lower end thereof. The terminating rods extend a distance of approximately 0.1 substantially perpendicular to and out from the conductive rod. Each terminating rod further includes a tail section that extends inwardly and substantially parallel to the intermediate conductive rod a distance of approximately 0.25.

### FIELD OF THE INVENTION

The invention relates to an improved turnstile antenna element for use in a Super-turnstile Antenna.

### BACKGROUND OF THE INVENTION

Turnstile antennas have been used for nearly a century and involve the use of some of the most rudimentary antenna components. As shown in FIG. 1, Electronics Research Inc. has produced a basic turnstile antenna for about 3 years called the “Crucis.” It is obvious from the shape of the antenna elements how it acquired the name “turnstile.” The antenna element is comprised of two “crossed” dipoles: dipoles in the same plane and rotated 90 degrees apart from each other. The dipoles are fed with the same signal amplitude with a 90 degree relative phase, often produced with an equal power divider and transmission lines differing a quarter-wave in length, or a Quadrature Hybrid (3 dB, 90 degree).

“Batwing” antenna elements progressed from the basic turnstile design. The dipole elements progressed to the “wing” elements which have an improved inter-element coupling (mutual coupling) and radiation characteristics. In use, the batwing turnstiles are arranged along the tower in a stacked array as shown in FIG. 2, in what is commonly referred to as a “Super-turnstile antenna.” FIG. 3 shows the basic outline of a batwing antenna and the preferred or optimal dimensions thereof as a function of wavelength( ). The current state of the art “batwing” super-turnstile antennas have radiating element wing dimensions of 0.7 long by 0.3 wide.

As a substitute for the traditional cylindrical pole tower, ERI has proposed in application Ser. No. 60/745,516, a lattice type support structure, through the confines of which transmission lines may be routed. This lattice structure permits the supporting structure itself to serve as a screen, shielding the transmission lines from the radiated field. However, the use of standard geometry batwing elements in conjunction with this lattice support structure has presented some problems. In order to provide the requisite structural stability, the horizontal cross section of the lattice support structure is significantly larger than that of a traditional support mast. The minimum practical dimensions of such a lattice support structure are in the range of 12″×12″, and preferably in the range of 15″×15″. Accordingly, the slot or gap between opposing batwing elements is significantly larger as is the distance from the outer edges of opposing batwing elements, particularly when the radiating elements are positioned on the vertical legs of the lattice structure.

When standard geometry batwing elements are used in conjunction with a 15″×15″ lattice support structure, deep nulls in the azimuth pattern occur. For example, for a frequency in the range of 195 MHz, a standard geometry batwing element would have a maximum width (Wmaj) of 13.5″ (0.22). As shown in FIG. 4, the azimuth pattern of such an antenna exhibits nulls in the range of 6 dB. Furthermore, at higher frequencies, the nulls are even deeper.

By decreasing the maximum width (Wmaj) of the batwing element, one realizes a reduction in nulls in the azimuth pattern. However, this reduction comes at the expense of degraded impedance. As shown in FIG. 5, reduction of the maximum width (Wmaj) of the batwing element from 13.5″ to 10″ produces smaller nulls in the range of 4 dB. However, as shown in FIG. 6, the impedance is significantly degraded.

### SUMMARY OF THE INVENTION

Accordingly, there is a need for a radiating element that can be used in conjunction with a lattice support structure, while maintaining nulls in the azimuth pattern of less than 4 dB while maintaining the desired impedance. The present invention fulfills this need by providing an improved radiating element

According to one aspect of the present invention the improved radiating element includes an intermediate conductive rod having an upper terminating rod connected thereto proximal to an upper end thereof and a lower terminating rod connected thereto proximal to a lower end thereof. The upper and lower terminating rods each include a substantially horizontally extending section having a first end connected to the intermediate conductive rod, and a second end connected to a tail section extending inwardly and substantially parallel to the intermediate conductive rod.

The distance between the upper and lower terminating rods is preferably 0.7. The substantially horizontally extending sections of each of the upper and lower terminating rods extend a distance of between 0.09 and 0.11, and preferably a distance of 0.1 substantially perpendicular to and out from said conductive rod. The length of each of said tail sections of each of the upper and lower terminating rods may be adjusted to tune the antenna, and preferably extends a distance of approximately 0.25.

Each substantially horizontally extending section of the upper and lower terminating rods is connected to a corresponding tail section by way of a curved or bent section of the respective upper or lower terminating rod. An upper horizontal support rod may also be provided for connecting the upper tail section to the intermediate conductive rod and a lower horizontal support rod connecting the lower tail section to the intermediate conductive rod. A substantially vertical connector rod may also be provided. The substantially vertical connector rod is preferably connected at an upper end thereof to the upper horizontal support rod and at a lower end thereof to the lower horizontal support rod. The substantially vertical connector rod further includes a center section that is substantially parallel to the intermediate conductive rod and spaced a distance Wmin therefrom. An upper angled section that angles away from said intermediate conductive rod and connects to the upper horizontal support rod is also provided, as well as a lower angled section that angles away from said intermediate conductive rod and connects to the lower horizontal support rod. A plurality of horizontal support rods extending between and connecting the substantially vertical connector rod and the intermediate conductive rod may also be provided.

The various members of the radiating element are formed of a conductive material, preferably aluminum or an aluminum alloy. The various rod members of the radiating element are also preferably formed from a tubular material. The diameter of the intermediate conductive rod may be greater than the diameter of the upper and lower terminating rods, in accordance with one aspect of the invention. The various members of the radiating element are affixed to one another by welds, according to one preferred embodiment of the present invention.

Upper and lower brackets positioned proximal to the upper and lower ends of the intermediate conductive rod may be provided for attaching the radiating element to a support structure, such as a lattice support tower. According to one aspect of the invention, the upper and lower brackets are affixed to a vertical support of the lattice support tower. Alternatively, the upper and lower brackets could be affixed to a cross-member on the face of the lattice support structure.

According to another aspect of the invention, an improved antenna is provided comprising a lattice support structure having a plurality of vertical support member spaced a distance apart from one another and connected to one another by a plurality of cross-members, and a plurality of improved antenna radiating elements. Each of the plurality of improved antenna radiating elements comprising an intermediate conductive rod having an upper end and a lower end; an upper terminating rod connected to the intermediate conductive rod proximal to the upper end thereof, and a lower terminating rod connected to the intermediate conductive rod proximal to a lower end thereof. The upper and lower terminating rods each include a substantially horizontally extending section having a first end connected to the intermediate conductive rod, and a second end connected to a tail section extending inwardly and substantially parallel to the intermediate conductive rod.

These and other objects, features and advantages of the present invention will become apparent with reference to the text and the drawings of this application.

### BRIEF DESCRIPTION OF THE DRAWINGS

FIG. 1 is a perspective view of a prior art turnstile antenna.

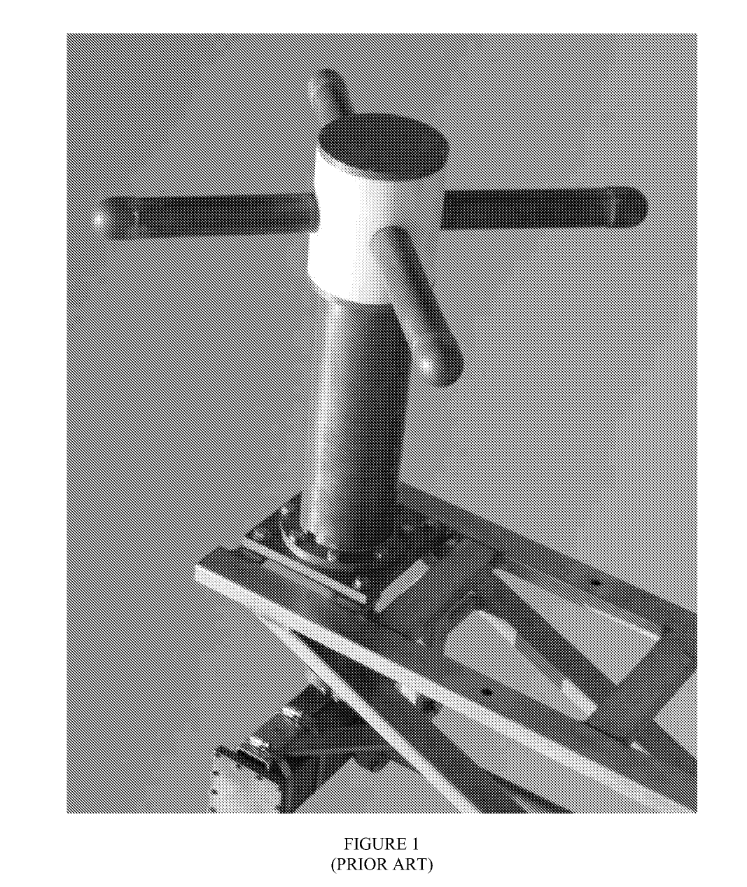

FIG. 2 is a perspective view of a prior art Super-turnstile antenna with “batwing” radiating elements.

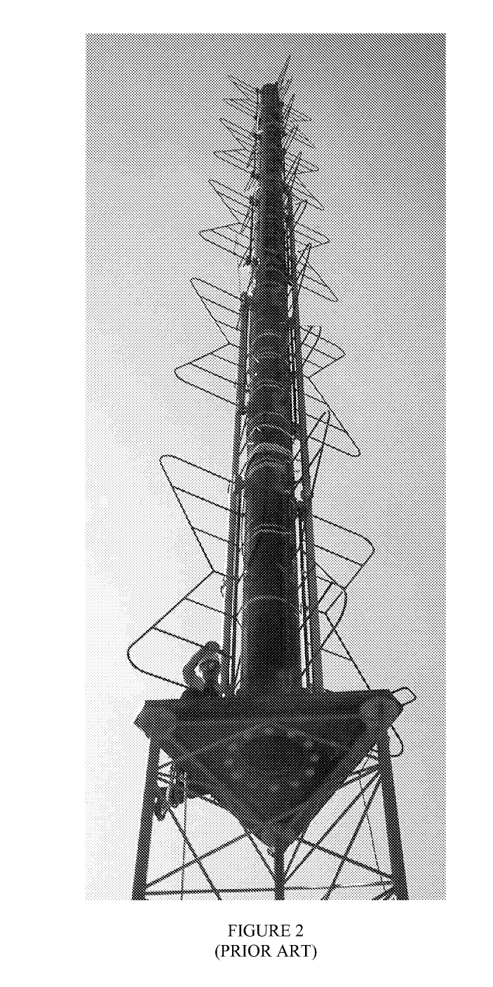

FIG. 3 is an outline sketch of a pair of “batwing” dipole radiating elements according to the prior art.

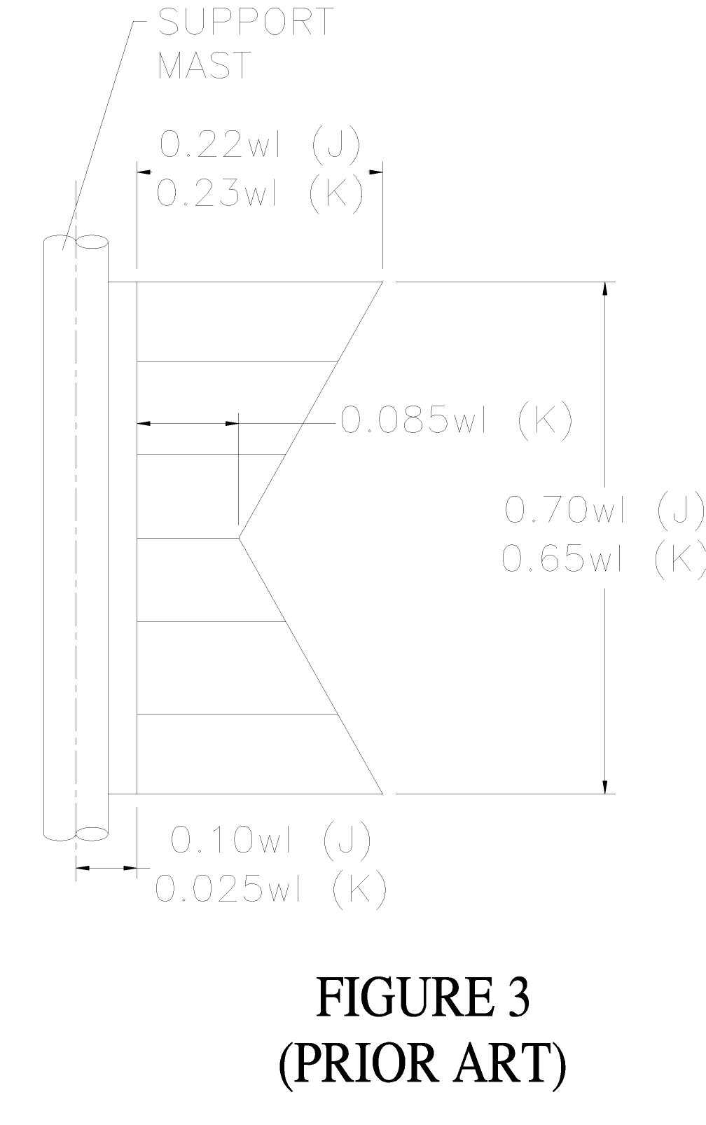

FIG. 4 is a rendering of the azimuth pattern at a frequency of 195 MHz of an antenna utilizing prior art batwing dipole elements on a lattice tower structure having a 15 inch face.

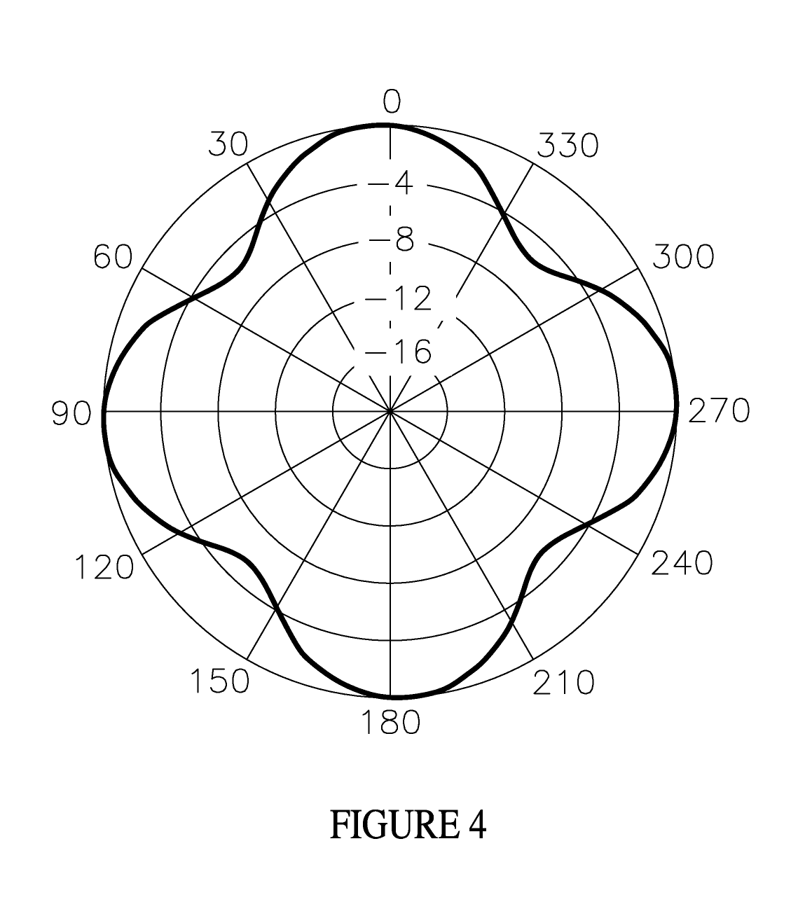

FIG. 5 is a rendering of the azimuth pattern at a frequency of 195 MHz of an antenna utilizing batwing dipole elements with a reduced width (10 inches) on a lattice tower structure having a 15 inch face.

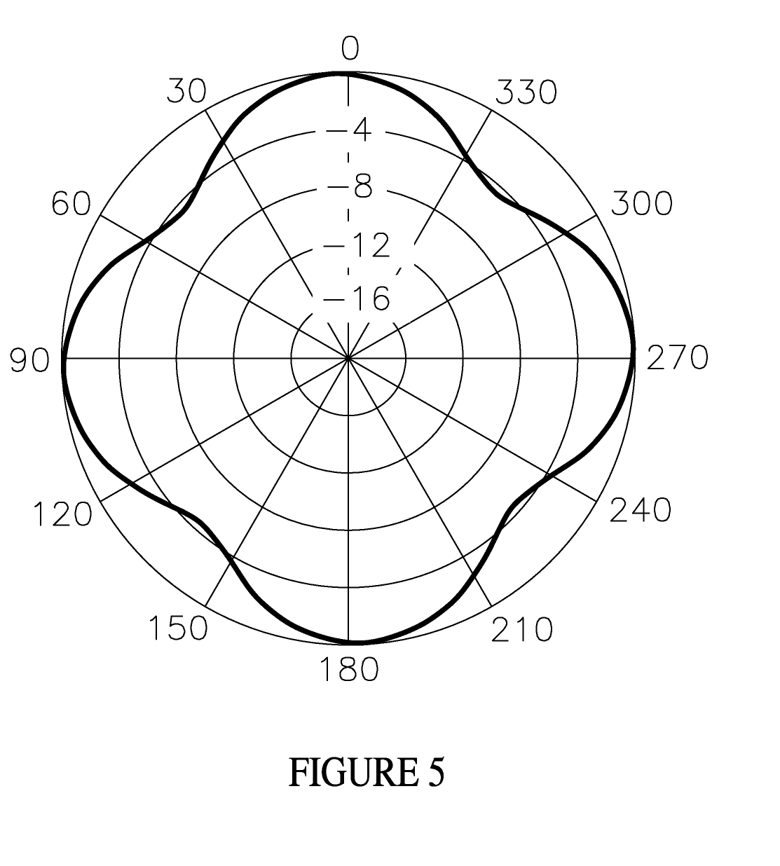

FIG. 6 shows a locus of points on a Smith Chart representing frequencies of 153 MHz, 174 MHz, 195 MHz, 216 MHz, and 237 MHz on an antenna utilizing batwing dipole elements with a reduced width (10 inches) on a lattice tower structure having a 15 inch face.

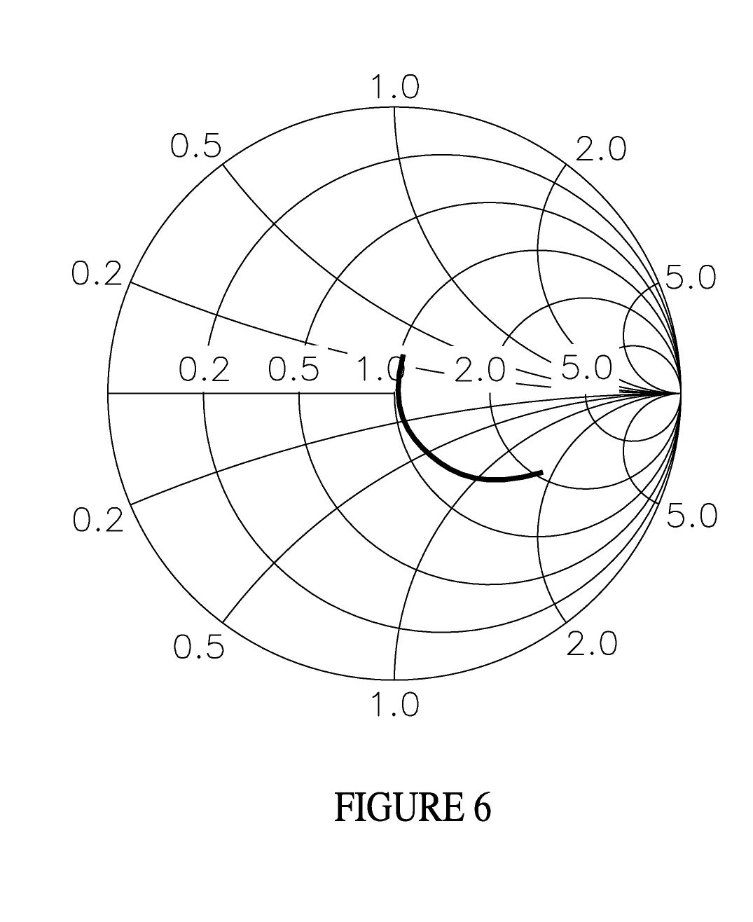

FIG. 7 is a side view in elevation of an improved radiating element according to a preferred embodiment of the present invention.

FIG. 8 is a perspective view of a turnstile arrangement of the radiating elements of FIG. 7 on a typical cylindrical tower support structure.

FIG. 9 is a perspective view of a turnstile arrangement of the radiating elements of FIG. 7 on the corners of a lattice tower structure.

FIG. 10 is a rendering of the azimuth pattern at a frequency of 195 MHz of a cross dipole antenna utilizing the radiating elements of FIG. 7 positioned on the corners of a 15 inch face lattice tower structure as shown in FIG. 9.

FIG. 11 shows a locus of points on a Smith Chart representing frequencies of 153 MHz, 174 MHz, 195 MHz, 216 MHz, and 237 MHz on an antenna utilizing the improved radiating elements of FIG. 7, having dimension of Wmaj=6.5″, Wmin=2.5″ and H1=15″ on the corners of a lattice tower structure having a 15 inch face as shown in FIG. 9.

FIG. 12 shows a locus of points on a Smith Chart representing frequencies of 153 MHz, 174 MHz, 195 MHz, 216 MHz, and 237 MHz on an antenna utilizing the improved radiating elements of FIG. 7, having dimension of Wmaj=6.5″, Wmin=2.5″ and H1=17″ on the corners of a lattice tower structure having a 15 inch face as shown in FIG. 9.

FIG. 13 shows a locus of points on a Smith Chart representing frequencies of 153 MHz, 174 MHz, 195 MHz, 216 MHz, and 237 MHz on an antenna utilizing the improved radiating elements of FIG. 7, having dimension of Wmaj=6″, Wmin=2″ and H1=15″ on the corners of a lattice tower structure having a 15 inch face as shown in FIG. 9.

### DETAILED DESCRIPTION

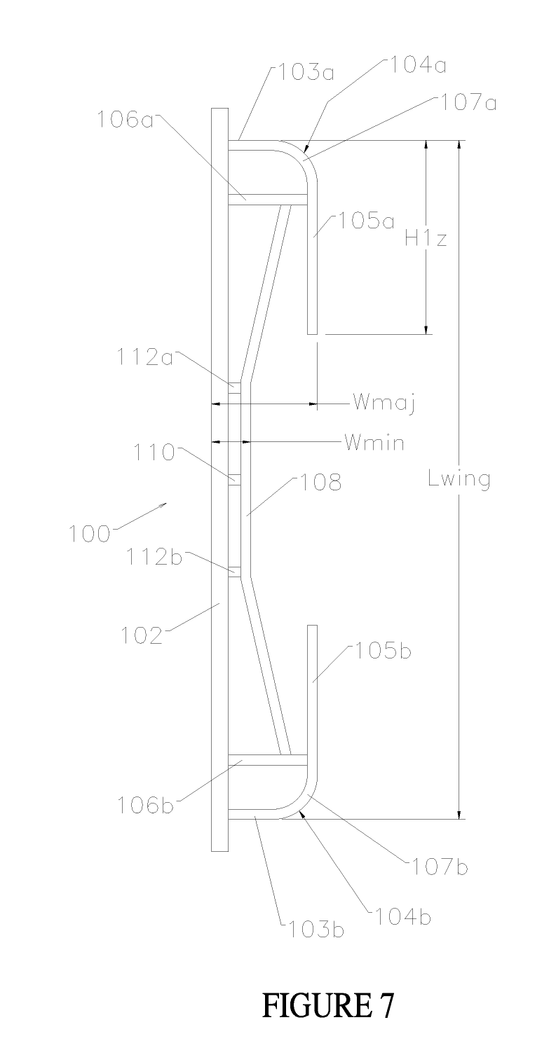

The present invention comprises an improved antenna radiating element 100 as shown in FIG. 7, comprising an intermediate conductive rod 102 having an upper terminating rod 104a proximal to an upper end thereof and a lower terminating rod 104b proximal to a lower end thereof. The terminating rods 104a, 104b extend a distance Wmaj substantially perpendicular to and out from the conductive rod 102. Each terminating rod 104a, 104b includes a tail section, 105a, 105b respectively, that extends inwardly and substantially parallel to the intermediate conductive rod 102 a particular distance H1z. According to one preferred embodiment shown in FIG. 7, each terminating rod includes a curved or bent section 107a, 107b respectively, disposed between the horizontally extending sections 103a, 103b and tail sections 105a, 105b.

The respective tail sections 105a, 105b of the terminating rods 104a, 104b are connected to the intermediate conductive rod 102 by horizontal support rods 106a, 106b. A substantially vertical connector rod 108 is connected at an upper end thereof to the upper horizontal support rod 106a and at a lower end thereof to the lower horizontal support rod 106b. The connector rod 108 had a center section that is substantially parallel to the intermediate conductive rod 102 and spaced a distance Wmin therefrom. At each end of the center section of the connector rod, end sections are provided that angle away from the intermediate conductive rod to the point of termination where the connector rod ends meet the respective horizontal support rods 106a, 106b. A center horizontal support rod 110 and intermediate horizontal support rods 112a, 112b are provided to connect the connector rod 108 and intermediate conductive rod 102.

The various members of the radiating element 100 are formed of a conductive material. Preferably, the members are formed from a light-weight metal material exhibiting superior strength and electrical conductive properties. Aluminum, more specifically AL 6061-T6, is one such preferred material. Tubular material is also preferred for each of the members of the radiating element 100. According to one preferred embodiment, ¾″ schedule 40 pipe with an outer diameter of 1.05″ may be used for the intermediate conductive rod 102, and ⅝″ rods may be used for the remaining members of the radiating element 100. The various members of the radiating element 100 are preferably affixed to one another by welds.

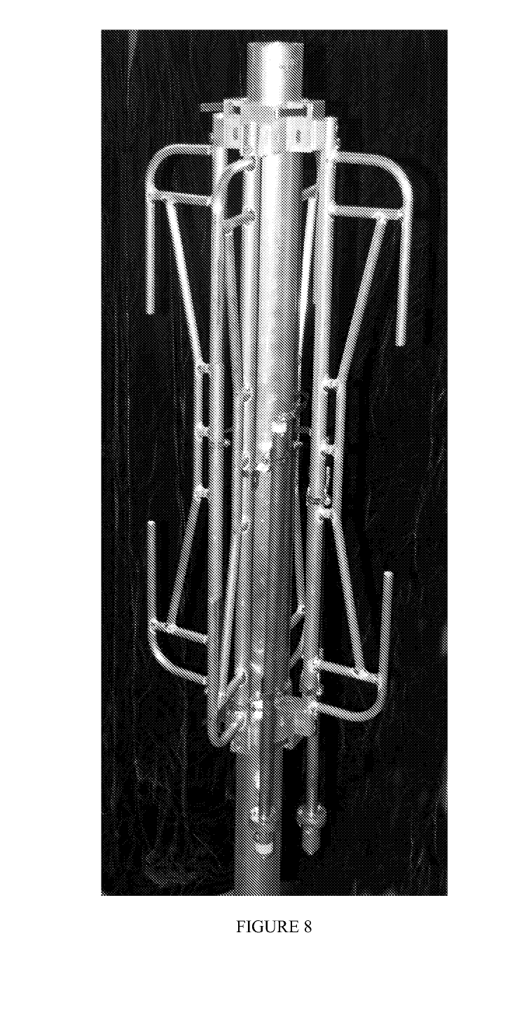

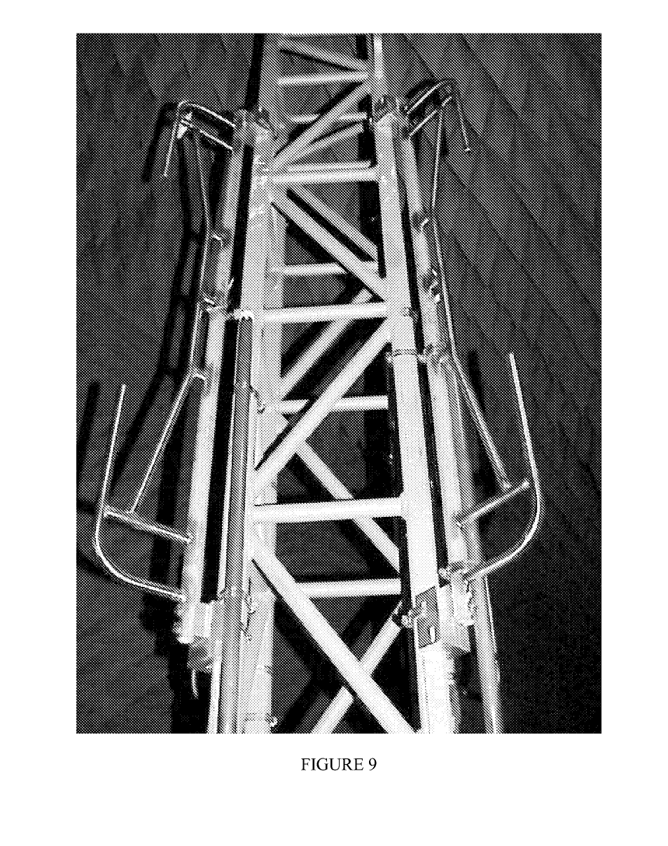

As shown in FIGS. 8 and 9, brackets may be provided at the respective ends of the intermediate conductive rod 102 in order to connect the rod to a supporting tower structure. FIG. 8 shows an array of radiating elements 100 in a turnstile configuration attached to a standard cylindrical supporting mast. FIG. 9 shows an array of radiating elements 100 in a turnstile configuration attached to the vertical support members of a square cross section lattice support structure.

The various dimensions, particularly Lwing, Wmaj, Wmin and H1z, of the radiating element are a function of the desired frequency of the antenna. As in the prior art “batwing” antenna, the length of the radiating element, Lwing, is optimally 0.7. A primary advantage of the present invention over the prior art “batwing” antenna is that the optimal length of the horizontal extension of the terminating rods 104a, 104b is reduced to between approximately 0.09 and 0.11, compared to approximately 0.23 for the batwing. The length, H1z, of the tail sections 105a, 105b of the terminating rods 104a, 104b can be varied to tune the antenna Optimal results are achieved at a length of approximately 0.25.

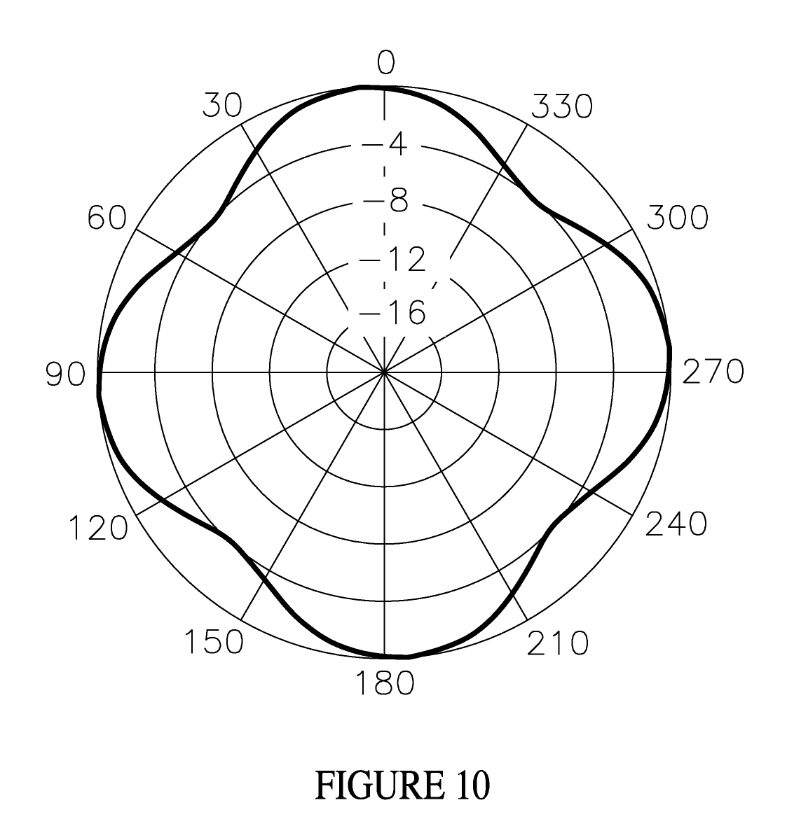

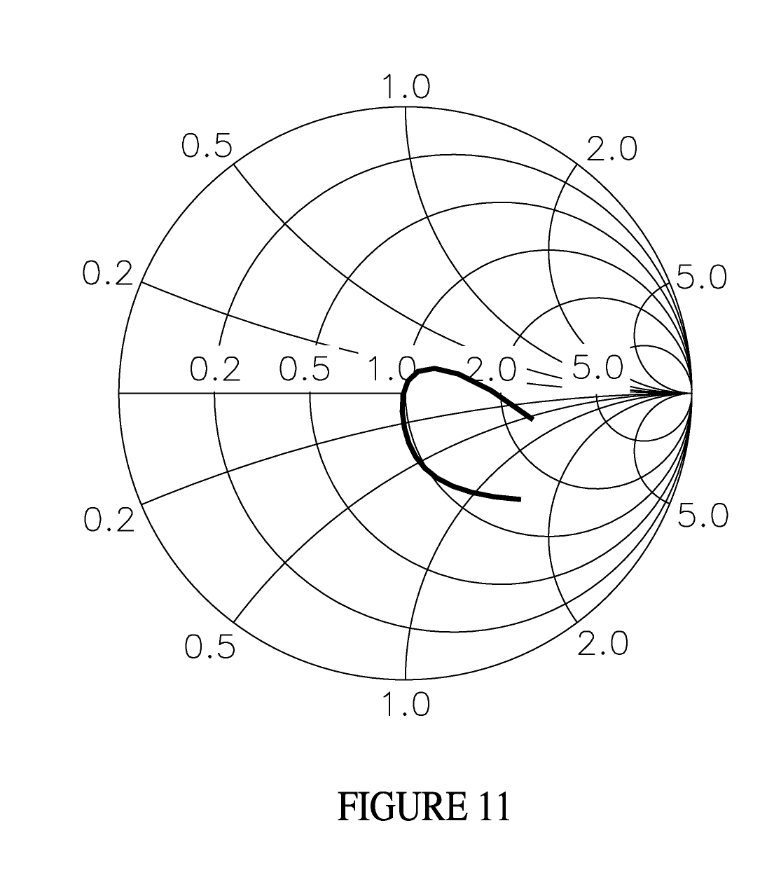

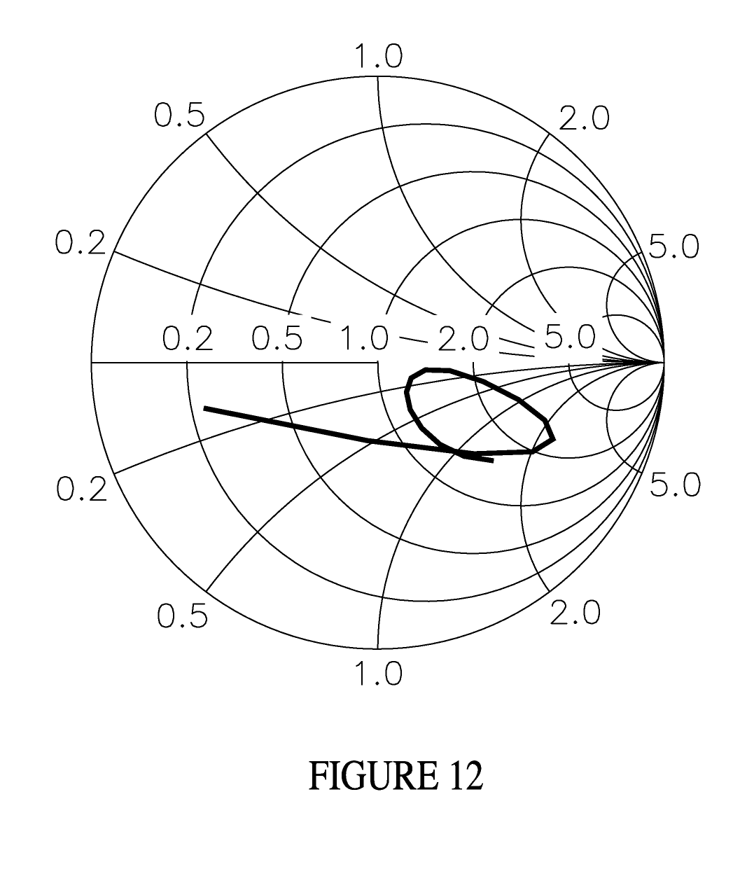

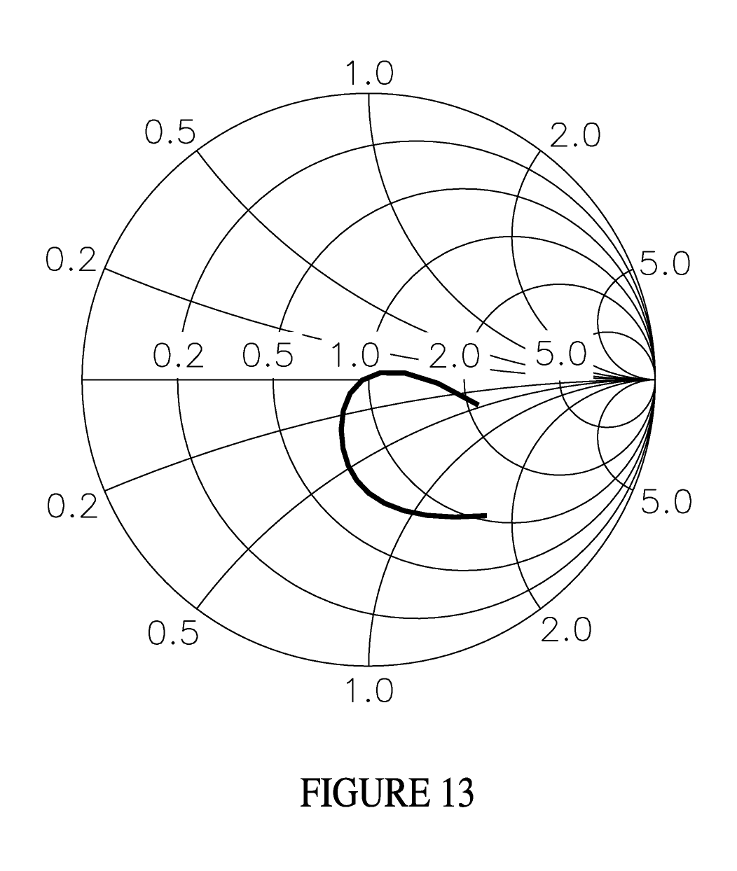

By way of example, for a frequency of 195 MHz, the wavelength, would be 60 (=c/frequency). As shown in FIG. 10, computer modeling suggests that use of an array of improved radiating elements 100 having a Wmaj=6.5″ (0.11); Wmin=2.5″ and H1z=15″ (0.25) on a square cross-section lattice support structure having 15″ faces produces smaller nulls, in the range of less than 4 dB. As shown in FIG. 11, the array having those dimension exhibits improved impedance as well when compared to the smaller batwing elements. Computer modeling suggests that the tail section 105 of the terminating rod 104 acts in much the same way as placing a load on the end of a traditional dipole. The addition of the tail sections 105a, 105b to the skinnier radiating element (Wmaj˜0.1) improves the impedance bandwidth (Z) at the expense of a slight degradation of the pattern parameters of az ripple and nadir lobe. It also appears that increasing the length of the tail section beyond 0.25 causes the impedance bandwidth (Z) to blow up, as shown in FIG. 12. As shown in FIG. 13, reduction of the Wmaj to 6.0″ (0.1) does not significantly degrade the impedance bandwidth (Z).

The foregoing is provided for purposes of illustrating, explaining, and describing embodiments of the present invention. Further modifications and adaptation to these embodiments will be apparent to those skilled in the art and may be made without departing from the scope or spirit of the invention.

I claim:

1. An improved radiating element for a turnstile antenna, comprising:
an intermediate conductive rod having an upper end and a lower end;
an upper terminating rod connected to said intermediate conductive rod proximal to the upper end thereof;
a lower terminating rod connected to said intermediate conductive rod proximal to a lower end thereof;
wherein said upper and lower terminating rods each include a substantially horizontally extending section having a first end connected to said intermediate conductive rod, and a second end connected to a tail section extending inwardly and substantially parallel to said intermediate conductive rod.

2. The improved radiating element of claim 1, wherein the distance between the upper and lower terminating rods is 0.7.

3. The improved radiating element of claim 2, wherein each of said substantially horizontally extending sections of each of the upper and lower terminating rods extends a distance of between 0.09 and 0.11 substantially perpendicular to and out from said conductive rod.

4. The improved radiating element of claim 3, wherein each of said substantially horizontally extending sections of each of the upper and lower terminating rods extends a distance of 0.1 substantially perpendicular to and out from said conductive rod.

5. The improved radiating element of claim 3, wherein the length of each of said tail sections of said upper and lower terminating rods may be adjusted to tune the antenna.

6. The improved radiating element of claim 5, wherein the length of each of said tail sections of said upper and lower terminating rods extends a distance of approximately 0.25.

7. The improved radiating element of claim 1, wherein each substantially horizontally extending section of the upper and lower terminating rods is connected to a corresponding tail section by way of a curved or bent section of the respective upper or lower terminating rod.

8. The improved radiating element of claim 1, further comprising an upper horizontal support rod connecting the upper tail section to the intermediate conductive rod and a lower horizontal support rod connecting the lower tail section to the intermediate conductive rod.

9. The improved radiating element of claim 8, further comprising a substantially vertical connector rod connected at an upper end thereof to the upper horizontal support rod and at a lower end thereof to the lower horizontal support rod.

10. The improved radiating element of claim 9, wherein the substantially vertical connector rod comprises a center section that is substantially parallel to said intermediate conductive rod and spaced a distance Wmin therefrom, an upper angled section that angles away from said intermediate conductive rod and connects to said upper horizontal support rod, and a lower angled section that angles away from said intermediate conductive rod and connects to said lower horizontal support rod.

11. The improved radiating element of claim 10, further comprising a plurality of horizontal support rods extending between and connecting said substantially vertical connector rod and said intermediate conductive rod.

12. The improved radiating element of claim 1, wherein the various members thereof are formed of a conductive material.

13. The improved radiating element of claim 12, wherein the various members thereof are formed from an aluminum alloy.

14. The improved radiating element of claim 13, wherein the various rod members thereof are formed from a tubular material.

15. The improved radiating element of claim 14, wherein the diameter of the intermediate conductive rod is greater than the diameter of the upper and lower terminating rods.

16. The improved radiating element of claim 14, wherein the various members of the radiating element are affixed to one another by welds.

17. The improved radiating element of claim 1, further comprising an upper bracket positioned proximal to the upper end of the intermediate conductive rod, and a lower bracket positioned proximal to a lower end of the intermediate conductive rod for attaching the radiating element to a support structure.

18. The improved radiating element of claim 17, wherein the support structure is a lattice support tower.

19. The improved radiating element of claim 18, wherein the upper and lower brackets are affixed to a vertical support of said lattice support tower.

20. An improved antenna comprising:
a lattice support structure having a plurality of vertical support member spaced a distance apart from one another and connected to one another by a plurality of cross-members; and
a plurality of improved antenna radiating elements, each of said plurality of improved antenna radiating elements comprising an intermediate conductive rod having an upper end and a lower end; an upper terminating rod connected to said intermediate conductive rod proximal to the upper end thereof; a lower terminating rod connected to said intermediate conductive rod proximal to a lower end thereof; wherein said upper and lower terminating rods each include a substantially horizontally extending section having a first end connected to said intermediate conductive rod, and a second end connected to a tail section extending inwardly and substantially parallel to said intermediate conductive rod.
